(19) United States
(12) Patent Application Publication
(10) Pub. No.: US 2015/0120601 A1
(43) Pub. Date: Apr. 30, 2015

(54) ELECTRONICALLY CONTROLLED PARCEL DELIVERY SYSTEM

(71) Applicant: Florence Manufacturing Company, Manhattan, KS (US)

(72) Inventor: Kevin A. Fee, Manhattan, KS (US)

(73) Assignee: Florence Manufacturing Company, Manhattan, KS (US)

(21) Appl. No.: 14/063,080

(22) Filed: Oct. 25, 2013

(51) Int. Cl. G06Q 10/08

(52) U.S. Cl. CPC G06Q 10/0836
USPC 705/339

(57) ABSTRACT

A parcel delivery system includes a parcel locker system for receiving and storing parcels; a portable electronic device used by a person who delivers parcels to the parcel locker; a portable electronic device operated by an intended recipient of a parcel; and encoded tags to be affixed to parcels to be delivered to the parcel locker system. The parcel locker system may comprise a number of individual parcel lockers and a control device for controlling access to the lockers.

### BACKGROUND

E-commerce continues to replace product sales from traditional brick and mortar stores and has dramatically increased the number of parcel deliveries by UPS, FedEx, and other delivery companies. This trend has also resulted in more missed deliveries and re-deliveries because many consumers often aren't home when deliveries are attempted and don't have secure storage areas where parcels can be left unattended. Missed deliveries are inconvenient for consumers and costly for parcel delivery companies and thus limit the desirability and growth of e-commerce. To reduce the number of missed deliveries, many parcel delivery companies send consumers email messages, texts, or other alerts to remind them of pending deliveries. However, even when consumers are home to accept deliveries, delivering parcels, typically one or two at a time to several different locations, is inefficient and costly.

Conventional post office (PO) boxes are an existing low-technology solution to some of the above described problems. Consumers can rent PO boxes in locations convenient to them and have packages delivered to and picked up from the boxes. This essentially eliminates missed deliveries and increases the efficiency of parcel delivery companies because they can often simultaneously deliver several packages to adjacent PO boxes. PO boxes are also easy to use because consumers don't have to identify themselves each time they attempt to pick-up a delivered parcel. Despite these advantages, PO boxes still aren't widely used because many consumers don't want to pay for them, especially since they remain empty and unused much of the time. Moreover, consumers must either rent a box that is big enough to accept the biggest parcel they may receive (and pay the increased cost for the larger box) or risk missed deliveries for parcels that don't fit in a smaller PO box. These and other limitations have prevented the widespread adoption of PO boxes.

Electronically controlled parcel locker systems are a more recent and higher tech solution to some of the above described problems. Such locker systems typically include a number of individual parcel lockers, each including a door and an electrically-operated locking mechanism for locking and unlocking the door, and a centralized kiosk or other control mechanism for controlling access to the parcel lockers. The kiosk communicates with a remote computer network to coordinate the receipt and storage of parcels in the lockers, identify and verify consumers against a registered consumer database, and associate a particular consumer with a parcel that is stored in one of the lockers. As with PO boxes, such parcel locker systems essentially eliminate missed deliveries and provide delivery efficiencies due to their centralized locations. Moreover, these systems have the added advantage of not requiring users to continuously rent a dedicated box of a particular size. Instead, these systems are typically owned by and paid for by property owners or delivery companies and have a variety of differently-sized lockers that can be used on an as-needed basis to accommodate parcels of a variety of sizes.

Unfortunately, electronically controlled parcel locker systems are expensive to build and operate. In addition to the initial purchase and assembly costs of the parcel lockers, owners must pay for, maintain, and operate the remote computer networks that communicate with and control the use of the parcel lockers. The second set of expenses is the greater of the two, both initially and over time, and has limited the use of such locker systems to high traffic and high use areas. Moreover, some consumers are reluctant to use existing electronically controlled parcel locker systems because they are relatively complicated and confusing when compared to conventional at-home deliveries and low-tech PO boxes.

### SUMMARY

The present invention solves at least some of the above-described problems and provides a distinct advance in the art of parcel delivery systems. More particularly, the present invention provides an electronically controlled parcel delivery system that is less expensive to build and operate and easier to use.

An embodiment of the parcel delivery system broadly comprises a parcel locker system for receiving and storing parcels; a portable electronic device used by a person who delivers parcels to the parcel locker; a portable electronic device operated by an intended recipient of a parcel; and encoded tags to be affixed to parcels delivered to the parcel locker system. Embodiments of the system may also comprise computer programs for implementing functions on some of these components.

An embodiment of the parcel locker system may comprise a number of individual parcel lockers and a control device for controlling access to the lockers. The parcel lockers may be grouped in cabinets, distributed throughout a room, or even integrated into existing cabinets, walls, bars, etc. Each of the lockers includes a door and an electrically operated locking mechanism for locking and unlocking the door.

The control device wirelessly communicates with the locking mechanism on the lockers and the portable electronic devices operated by the delivery person and the parcel recipient. An embodiment of the control device includes a short range wireless radio transceiver; a long range wireless radio transceiver; and a processor. The processor includes a computer program that allows it to interact with the tags on the parcels and the portable electronic devices operated by the delivery person and the recipient as described in more detail below. The control device also maintains an electronic log indicating the size of the lockers and which ones are currently occupied. In one embodiment, the control device is a handheld mobile communication device such as a wireless smart phone that is mounted in a location with sight lines to all the parcel lockers.

The portable electronic devices operated by the delivery person and the intended recipient each include a short range wireless radio transreceiver, a long range wireless radio transreceiver, and a processor. The devices are programmed with applications that enable them to interact with the tags on the parcels and the control device of the parcel locker system. The portable electronic device may also be wireless smart phones.

The tags applied to the parcels may be near field communication (NFC) tags, radio frequency identification (RFID) tags, bar coded tags, or any other machine readable devices. Each tag is encoded with identification information described below and is associated with and attached to a particular parcel to be delivered to the parcel locker system.

Embodiments of the parcel delivery system may be used as follows. A consumer first requests delivery of a parcel to the parcel locker system in any conventional way. For example, the consumer may order a product from a vendor's website and request that the product be shipped to the parcel locker system. As part of this transaction with the vendor, the consumer may provide information identifying himself, such as his name, address, contact information etc.

The vendor or another person then encodes one of the tags with identification information and applies it to the parcel containing the ordered product. The identification information may include information identifying the vendor; information about the parcel itself, such as its content, size, and weight; information about the parcel locker system, such as its address; and information about the parcel's intended recipient, such as his or her name, address, and contact information. The identification information may also include a code associated with the particular parcel and/or the recipient.

The vendor then mails or ships the parcel in a conventional manner. At some point in the delivery of the parcel from the vendor to the parcel locker system, a delivery person, such as the driver of a UPS or FedEx truck, uses his portable electronic device to read at least some of the identification information from the tag on the parcel. For example, if the tag is an NFC tag, the delivery person may place his portable electronic device next to the tag to trigger its short range wireless transceiver to read the identification information on the tag. After reading the identification information, the portable electronic device may trigger its long range wireless radio transceiver to send a message containing at least some of the identification information to the control device of the parcel locker system to notify the control device the parcel will soon be delivered.

After receiving the message from the delivery person's portable electronic device, the control device may determine whether the parcel locker system has an available locker of an appropriate size for the parcel. If it does, the control device sends a corresponding message back to the delivery person's portable electronic device to let him know it's okay to make the delivery. If a locker isn't currently available, the control device sends a corresponding message back to the delivery person's portable electronic device to instruct him to delay the delivery until a locker is available or to deliver the parcel to another locker system. The control device may also monitor the status of its lockers and automatically send a follow-up message to the delivery person's portable electronic device as soon as a locker is available.

The portable electronic device of the delivery person may also send a message to the portable electronic device of the recipient of the parcel to notify the recipient the parcel will soon be delivered to the parcel locker system. The message may also inform the recipient the parcel will be delivered to an alternative parcel locker system if the originally selected parcel locker system is full.

The information encoded in the tag on the parcel is also used to select a locker for the parcel. After the delivery person arrives at the parcel locker system, he places the parcel next to the control device so the control device can read the identification information from the tag on the parcel. The control device uses this information to select an available locker for the parcel and to later identify the recipient. Specifically, the processor reads the identification information to determine the size of the parcel and compares the size against the electronic log indicating which lockers are currently available and their sizes. The processor then selects an available locker that can accommodate the size of the parcel. Because the size of the parcel is encoded on its tag and automatically read by the control device, an appropriately-sized locker is automatically selected so that the delivery person does not have to select one.

The control device then opens the door of the selected locker. Specifically, the control device triggers its short range wireless radio transmitter to signal the electronically operated locking mechanism of the selected locker to unlock its door so the parcel may be placed in the parcel locker. The delivery person then places the parcel in the open locker and closes the door.

The control device may also transmit a message to the recipient's portable electronic device to notify the recipient of the receipt of the parcel in the parcel locker. Importantly, the message includes at least some of the identification information read from the tag on the parcel.

The recipient may then use his portable electronic device to retrieve the parcel from the parcel locker system. The message sent to the recipient directs the recipient to bring his portable electronic device to the parcel locker system for identification purposes. When the recipient arrives at the parcel locker system, he may simply place his portable electronic device next to the control device. The control device senses the portable electronic device, or vice versa, and reads at least part of the identification information that was sent to the portable electronic device. If this information matches the identification information previously read from the tag of the parcel, the control device instructs its short range transceiver to signal the electronically operated locking mechanism of the locker in which the parcel was placed to unlock its door so the parcel may be retrieved from the locker. The recipient can then remove the parcel from the open locker. The control device may also send messages to the vendor and/or the recipient to confirm that the parcel was successfully picked up.

The above-described parcel delivery system offers numerous advantages. For example, because the system reads identification information encoded on a tag affixed to a parcel and then sends such identification information to a portable electronic device operated by the recipient, the recipient can be quickly and easily identified at the parcel locker system by simply placing his portable electronic device in the vicinity of the control system of the parcel locker system. Importantly, neither the parcel locker system nor the recipient has to access a remote computer network to verify the identity of the recipient. Moreover, the recipient doesn't have to type in codes or other identification information into a kiosk, and/or carry and insert key cards, etc. Similarly, a delivery person doesn't have to select a locker for the parcel or enter codes to access the locker.

Additionally, because all communication between the control device, portable electronic devices, and lock operators is wireless, no wires are required between the control device and the individual parcel lockers. This permits the parcel lockers to be distributed throughout a room or even incorporated in existing walls, counters, etc. One advantage of such a configuration is that some of the parcel lockers may be positioned or otherwise configured to be compliant with disability regulations.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic view of components of an electronically controlled parcel delivery system that may be used to implement aspects of the present invention.

FIG. 2 is a perspective view of a parcel locker system constructed in accordance with an embodiment of the present invention.

FIG. 3 is a perspective view of a parcel locker system constructed in accordance with another embodiment of the present invention.

FIG. 4 is a fragmentary front perspective view of a section of the parcel locker systems of FIG. 2 or 3 illustrating one of the storage locker doors in an open position and a portion of an outer wall removed to reveal locking mechanisms used to selectively lock and unlock the lockers.

FIG. 5 is a block diagram of selected components of the control device of the parcel locker system of FIG. 2 or 3.

FIG. 6 is a block diagram of components of a portable electronic device operated by a delivery person or an intended recipient of a parcel delivered to the parcel locker systems of FIG. 2 or 3.

FIG. 7 is a perspective view of a parcel that may be delivered to and stored in the parcel locker system of FIG. 2 or 3.

FIG. 8 is a flow diagram depicting steps of methods of the present invention and/or portions of computer programs of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

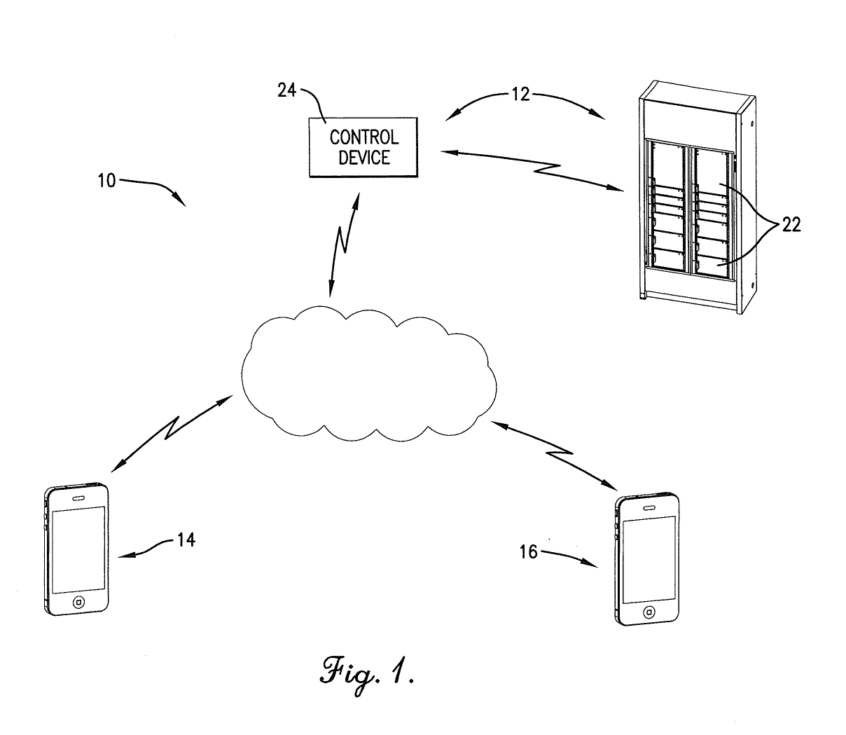

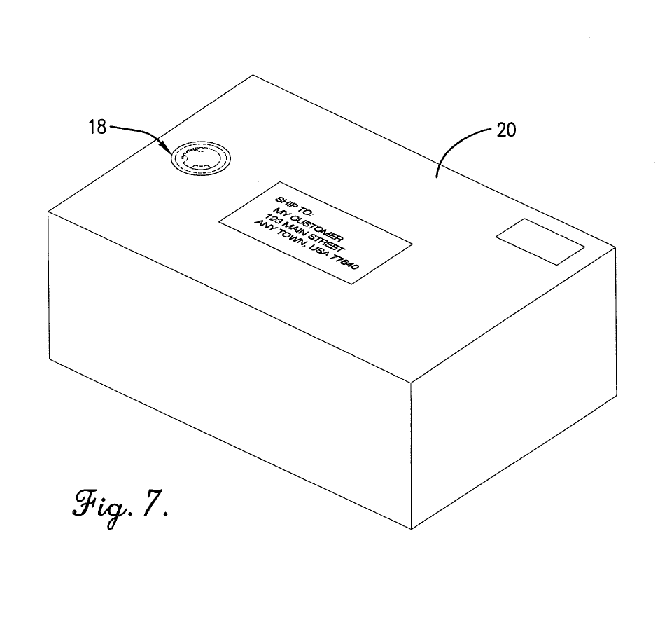

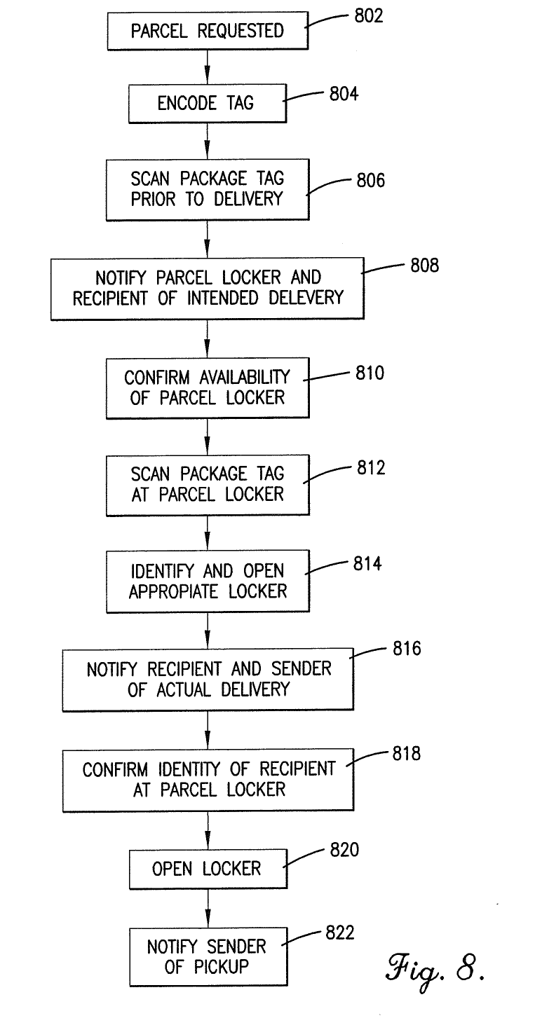

Turning now to the drawing figures, and initially FIGS. 1 and 7, a parcel delivery system 10 constructed in accordance with embodiments of the present invention is illustrated. The illustrated parcel delivery system 10 broadly comprises a parcel locker system 12 for receiving and storing parcels; a portable electronic device 14 used by a person who delivers parcels to the parcel locker system 12; a portable electronic device 16 operated by an intended recipient of a parcel; and an encoded tag 18 affixed to a parcel 20 to be delivered to the parcel locker system 12. The system 10 may include any number of parcel locker systems 12, portable electronic devices 14, portable electronic devices 16, tags 18, and parcels 20, but only one of each is illustrated in FIGS. 1 and 7 and described in detail herein for simplicity. Embodiments of the invention may also include one or more computer programs for implementing functions of the invention as described below.

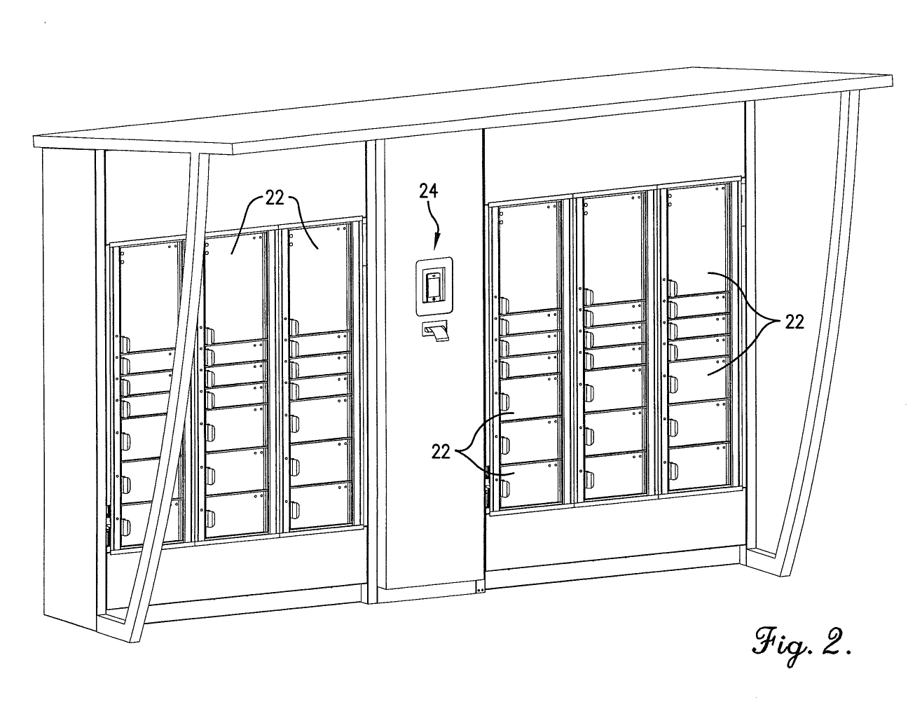

Embodiments of the parcel locker system 12 will now be described in more detail with reference to FIGS. 2-5. The parcel locker system 12 may be located indoors or outdoors at any location such as postal or shipping stations, apartment buildings, gas stations, retail stores, shopping or entertainment venues, bus terminals, airports, or other areas convenient to consumers who regularly receive parcels via mail and shipping services. The parcel locker system 12 may be of any size and shape and constructed of any suitable materials.

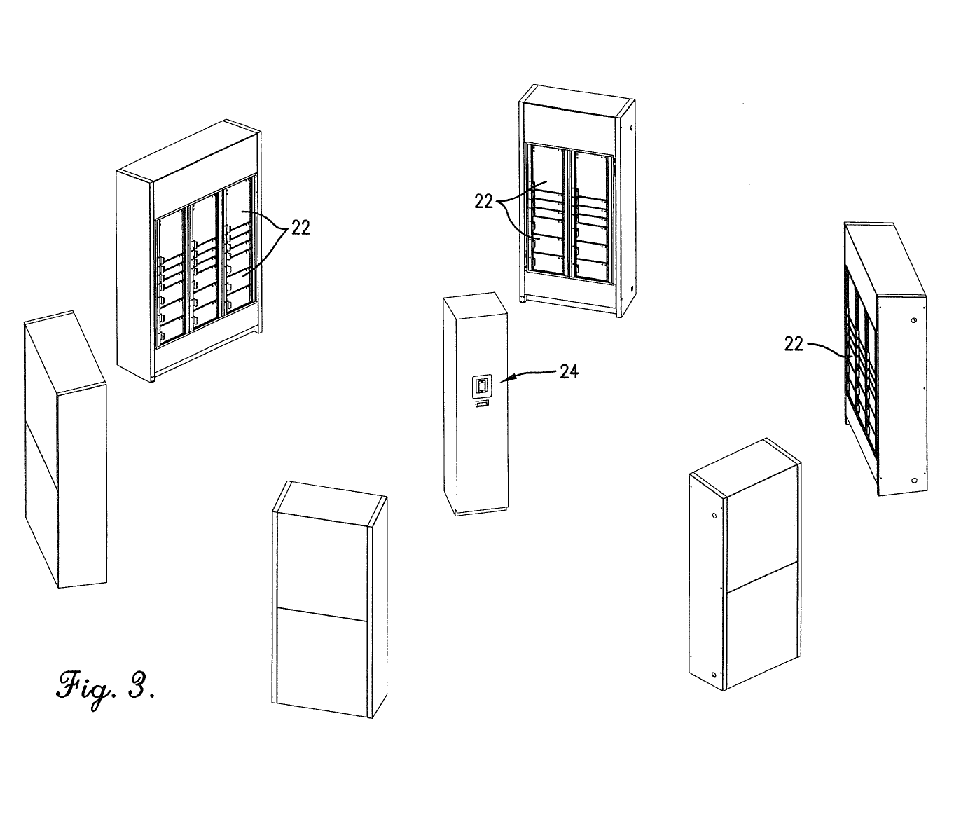

The parcel locker system 12 broadly comprises a number of individual parcel lockers 22 and a control device 24 for controlling access to the lockers. The parcel lockers may be arranged in rows, columns or both and may be of different sizes and shapes. The lockers 22 may be grouped in cabinets and supported in a single housing or enclosure as depicted in FIG. 2 or may be distributed throughout a room or other area as depicted in FIG. 3. Because of unique operational aspects of the parcel delivery system 10 described below, the lockers 22 may even be integrated into existing cabinets, walls, bars, etc.

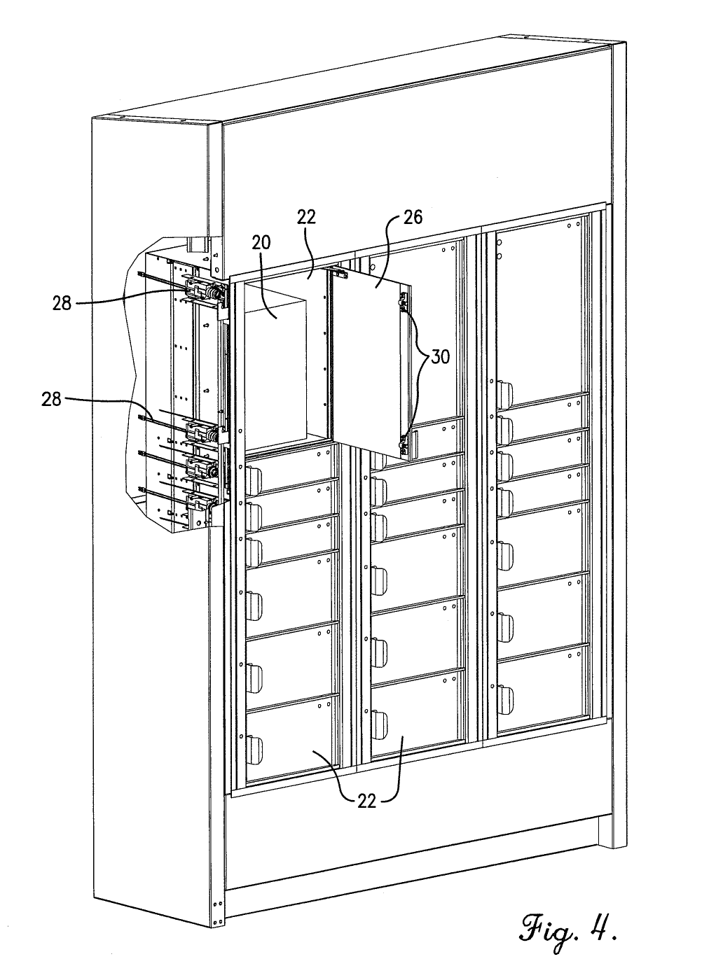

As best seen in FIG. 4, each locker 22 includes a door 26 and at least one electrically operated locking mechanism 28 for locking and unlocking the door. In a particular embodiment, each locker 22 includes one or more latch elements 30 that each engage latches to lock the door in a closed position. The latch elements 30 may be pins or other mechanisms positioned on the doors and the latches may be any mechanisms which selectively latch or unlatch the pins. The locking mechanisms 28 selectively engage and disengage the latches to lock and unlock the door in response to signals from the control device 24. Each locking mechanism 28 includes a wireless receiver and chip set so it can be wirelessly controlled by the control device 24 as described below.

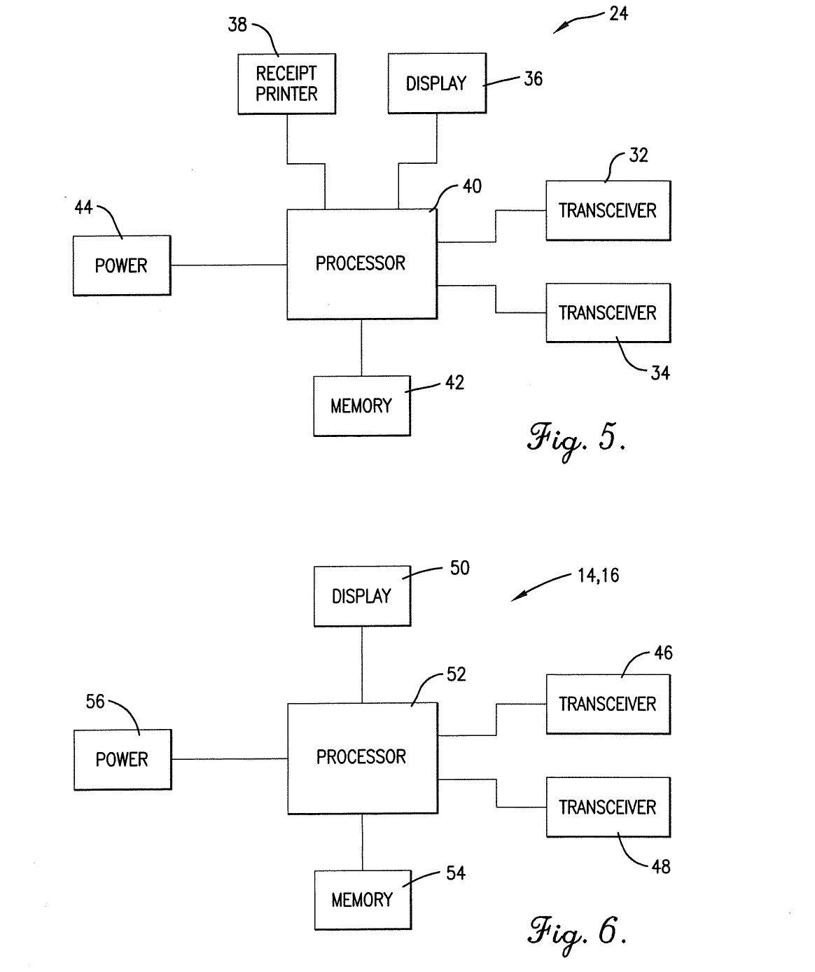

The control device 24 controls access to the lockers 22 and performs other functions described below. An embodiment of the control device 24 is illustrated in FIG. 5 and includes a short range wireless radio transceiver 32; a long range wireless radio transceiver 34; a display 36, a receipt printer 38, a processor 40, memory 42, and a power source 44.

The short range wireless radio transceiver 32 is provided for controlling or otherwise communicating with the locking mechanisms 28 of the parcel lockers 22, the tag 18 on the parcel 20, and the portable electronic devices 14,16 operated by the delivery person and parcel recipient as described in more detail below. The short range wireless transceiver 32 may employ Bluetooth, Wi-Fi, and/or near field communication (NFC) communication protocols and may be a single device or may include multiple different transceivers.

The long range wireless radio transceiver 34 is provided for longer range communications with the portable electronic devices 14,16 as described in more detail below. The long range wireless transceiver 34 may employ any cellular radio communication protocols for transmission and receipt of communications over any cellular communication network.

The display 36 provides visual instructions to users of the system 10 and may be of any size and shape and may employ any known display technologies such as liquid crystals, light emitting diodes, or plasma display panels. Some embodiments of the system 10 may not include a display.

The receipt printer 38 is provided for printing receipts or other evidence that a parcel has been delivered to or picked up from one of the parcel lockers 22. The printer 38 may be any type of printing device. Some embodiments of the system 10 may not include a receipt printer.

The processor 40 controls the other components of the control device 24 and may include various analog and digital components operable to perform the various functions discussed herein. In some embodiments, the processor 40 may include a microprocessor, a microcontroller, a programmable logic device, digital and analog logic devices or, computing elements such as personal computers, servers, portable computing devices, combinations thereof, and the like.

The memory 42 may be coupled with or integral to the processor 40. The memory may include any non-transitory computer-readable memory or combination of computer-readable memories operable to store data for use by the processor. For example, in one embodiment, the memory stores an electronic log indicating the size of the lockers 22 and which ones are currently occupied. The memory 12 also temporarily stores information received from the portable electronic device 14 and identification information read from the tag 18 as described in more detail below.

The power source 44 provides power to the other components of the control device 24 and may be a battery or a hard-wired connection to a 120 VAC power source.

In one embodiment, all of the components of the control device except for the receipt printer are provided in such as those provided by Apple, Samsung, or Motorola a wireless smart phone.

The control device 24 may be mounted in the same overall housing as the lockers 22 as illustrated in FIG. 2 or may be mounted in a pedestal or other support as illustrated in FIG. 3 so that a user of the control device has an uninterrupted sight line to all the parcel lockers.

The portable electronic devices 14,16 communicate with the control device 24 and with each other to perform functions of the invention described below. The devices may be “smart” phones such as those provided by Apple, Samsung, or Motorola and each includes a short range wireless radio transreceiver 46, a long range wireless radio transreceiver 48, a display 50, a processor 52, memory 54, and a power source 56.

The short range wireless radio transceiver 46 is provided for communicating with the control device 24 of the parcel locker system and/or for reading information from the tag 18 on the parcel 20 as described in more detail below. The short range wireless transceiver 46 may employ Bluetooth, Wi-Fi, and/or near field communication (NFC) communication protocols and may be a single device or may include multiple different transceivers.

The long range wireless radio transceiver 48 is provided for longer range communications and may employ any cellular radio communication protocols for transmission and receipt of communications over any cellular communication network.

The display 50 may be of any size and shape and may employ any known display technologies such as liquid crystals, light emitting diodes, or plasma display panels.

The processor 52 may include various analog and digital components operable to perform the various functions discussed herein. In some embodiments, the processor may include a microprocessor, a microcontroller, a programmable logic device, digital and analog logic devices, computing elements such as personal computers, servers, portable computing devices, combinations thereof, and the like.

The memory 54 may be coupled with or integral to the processor 52 and may include any non-transitory computer-readable memory or combination of computer-readable memories operable to store data for use by the processor. The portable electronic devices are programmed with applications that enable them to interact with the tags on the parcels and the control device of the parcel locker system as described below.

The power source 50 may be a battery or other electricity source.

The tag 18 applied to the parcel 20 may be a near field communication (NFC) tag, radio frequency identification (RFID) tag, bar coded tag, or any other machine readable device. The tag 18 is encoded with identification information described below and is associated with and attached to the parcel 20 prior to being delivered to the parcel locker system 12.

The computer programs of the present invention may be stored in or on the memory 42, the memory 54, or other computer-readable medium residing on or accessible by the control device 24 and/or the portable electronic devices 14,16. Each computer program preferably comprises an ordered listing of executable instructions for implementing logical functions in its perspective device. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a computer-readable medium can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The flow chart of FIG. 8 shows the functionality and operation of an exemplary implementation of the present invention in more detail. In this regard, some of the blocks of the flow chart may represent method steps and/or a module segment or portion of code of the computer programs of the present invention. In some alternative implementations, the functions noted in the various blocks may occur out of the order depicted in FIG. 8. For example, two blocks shown in succession in FIG. 8 may in fact be executed substantially concurrently, or the blocks may sometimes be executed in the reverse order depending upon the functionality involved.

A consumer (also referred to herein as a “recipient”) first requests delivery of a parcel such as the parcel 20 to the parcel locker system 12 as depicted in block 802. Delivery of the parcel may be requested in any conventional manner. For example, the consumer may order a product from a vendor's website and request that the product be shipped to the parcel locker system 12. As part of this transaction, the consumer may provide to the vendor his name, address, contact information, and other identification information.

The vendor or another person then encodes a tag such as the tag 18 shown in FIG. 7 with identification information as shown in block 804. The identification information may include any information that identifies the vendor, the parcel, the locker system 12, and/or the recipient. For example, the identification information may include information about the vendor or other sender of the parcel, such as the vendor's name, address, and contact information. The identification information may also include information about the parcel itself, such as its content, size, and weight. The identification information may also include information about the parcel locker system 12, such as its address. Finally the identification information may include information about the parcel's intended recipient, such as his or her name, address, and contact information. Some embodiments of the identification information may also include an identifying code used by the parcel locker system 12 to identify the recipient as described below. The code may be a random number that is generated and associated with the particular tag 18 and parcel 20 or may be a code created from other parts of the identification information. After the tag is encoded with at least some of this identification information, it is applied to the parcel 20 containing the ordered product as shown in FIG. 7.

The vendor may then mail or ship the parcel 20 in a conventional manner. At some point in the delivery of the parcel 20 from the vendor to the parcel locker system 12, a delivery person, such as the driver of a UPS or FedEx truck, may use his portable electronic device 14 to read at least some of the identification information from the tag 18 on the parcel 20 as depicted in block 806. For example, if the tag is an NFC tag, the delivery person may place his portable electronic device 14 next to the tag 18 to trigger the short range wireless transceiver 46 to read the identification information on the tag. The processor 52 of the portable electronic device 14 may then temporarily store the identification information read from the tag 18 in its memory 54.

The processor 52 may then trigger its long range wireless radio transceiver 48 to send at least some of the identification information to the control device 24 of the parcel locker system 12 to notify the control device 12 the parcel 20 will soon be delivered as depicted in block 808.

In one embodiment, the identification information sent to the control devices of the parcel locker system allows it to determine if it has room for the parcel. Specifically, after receiving the identification information from the portable electronic device 14, the control device 24 may analyze the size of the parcel to determine whether the parcel locker system 12 has an available locker 22 of an appropriate size for the parcel as depicted in block 810. If it does, the control device 24 sends a corresponding signal back to the portable electronic device 14 to let him the delivery person know it's okay to make the delivery. If a locker isn't currently available, the control device 24 sends a corresponding message back to the portable electronic device 14 to instruct the delivery person to delay the delivery until a locker is available. The control device 24 may also monitor the status of the lockers 22 and automatically send a follow-up message to the portable electronic device 14 as soon as a locker is available.

The portable electronic device 14 may also trigger its long range wireless radio transceiver 48 to send a message to the portable electronic device 16 of the recipient to notify the recipient the parcel 20 will soon be delivered. The message may also inform the recipient that the parcel will be delivered to an alternative parcel locker system if the desired parcel locker system is full.

The tag 18 on the parcel 20 is also used to access a locker 22 in the parcel locker system 12. After the delivery person arrives at the parcel locker system 12, he places the parcel 20 next to the control device 24 so the short range wireless transceiver 32 of the control device can read the identification information from the tag 18 as depicted in box 812. The processor 40 may then temporarily store the identification information in its memory 42.

In one embodiment, the control device 24 uses the identification information read from the tag 18 to select an available locker 22 for the parcel 20. Specifically, the processor 40 obtains the size of the parcel from the identification information and compares the size against the electronic log in the memory 42 that indicates which lockers are currently available and their sizes. The processor 40 then selects an available locker that can accommodate the size of the parcel. Because information identifying the size of the parcel is encoded on its tag 18 and automatically read by the control device 24, an appropriately-sized locker is automatically selected so that the delivery person does not have to select one. The processor 40 then triggers its short range wireless radio transreceiver 32 to signal the electronically operated locking mechanism of the selected locker to unlock its door so the parcel may be placed in the parcel locker as depicted in block 814.

The control device 24 also sends a message to the portable electronic device 16 to inform the recipient that the parcel was delivered to the parcel locker system 12 as depicted in block 816. Specifically, the processor 40 triggers its long range wireless radio transceiver 34 to transmit a message to the recipient's portable electronic device 16. Importantly, the message includes at least some of the identification information read from the tag 18. The message also instructs the recipient to bring his portable electronic device 16 to the parcel locker system for identification purposes.

The recipient may then use his portable electronic device 16 to pick up the parcel 20 from the parcel locker system 12. When the recipient arrives at the parcel locker system, he may simply place his portable electronic device 16 next to the control device 24 to confirm his identity as depicted in block 818. The processor 40 of the control device 24 directs its short range wireless radio transceiver 32 to communicate with the recipient's portable electronic device 16 to read at least part of the identification information that was sent to the portable electronic device. The processor 40 then compares the identification information stored on the portable electronic device 16 to the identification information read from the tag 18 to verify the identity of the recipient and to associate the recipient with the parcel 20 stored none of the lockers 22. For example, the processor 40 may compare the code read from the tag 18 to the code sent to and now stored on the recipient's portable electronic device 18.

If the code or other identification information matches, the processor 40 triggers its short range wireless radio transceiver 32 to signal the electronically operated locking mechanism 18 of the locker 22 in which the parcel 20 was placed to unlock its door so the parcel may be retrieved from the locker as depicted in block 820. In the embodiment of the parcel locker system shown in FIG. 3, the recipient can quickly and easily locate the locker because he has a clear sight line to all the lockers due to the central positioning of the control device 24.

After the locker is opened, the control device 24 may send a message to the vendor or other sender of the parcel to confirm that the parcel was picked up as depicted in block 822. The recipient may even be asked to place the parcel in front of the control device 24 so that it may scan the tag 18 on the parcel 20 to confirm that the proper parcel 20 has been retrieved. Finally, the control device 24 may direct its recipient printer 38 to print a receipt indicating the parcel was successfully delivered and picked up.

The above-described parcel delivery system 110 offers numerous advantages. For example, because the system reads identification information encoded on a tag affixed to a parcel and then sends such identification information to a portable electronic device operated by the recipient, the recipient can be quickly and easily identified and associated with the parcel by simply placing his portable electronic device in the vicinity of the control system of the parcel locker system. Importantly, neither the parcel locker system nor the recipient has to access a third party database to verify the identity of the recipient. Moreover, the recipient doesn't have to type in codes or other identification information into a kiosk, and/or carry and insert key cards, etc. This makes the system less expensive to purchase and operate and easier to use.

Additionally, because all communication between the control device, portable electronic devices, and lock operators is wireless, no wires are required between the control device and the individual parcel lockers. This permits the parcel lockers to be distributed throughout a room or even incorporated in existing walls, counters, etc. One advantage of such configuration is that some of the parcel lockers may be positioned or otherwise configured to be compliant with disability regulations.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A parcel locker system comprising:
a plurality of parcel lockers each including a door and an electrically operated locking mechanism for locking and unlocking the door; and
a control device configured for controlling access to the parcel lockers, the control device including—
a) a short range wireless radio transceiver;
b) a long range wireless radio transceiver; and
c) a processor programmed to—
i) direct the short range wireless radio transceiver to read a tag on a parcel being delivered to the parcel delivery system to obtain from the tag information identifying the parcel and an intended recipient of the parcel;
ii) trigger the short range wireless radio transceiver to signal one of the electronically operated locking mechanisms to unlock its door so the parcel may be placed in the parcel locker;
iii) trigger the long range wireless radio transceiver to transmit a message to a portable electronic device operated by the intended recipient to notify the intended recipient of the receipt of the parcel in the parcel locker, the message including information identifying the parcel and the intended recipient;
iv) direct the short range wireless radio transceiver to communicate with the portable electronic device operated by the intended recipient when the portable electronic device is placed near the control device to read at least part of the information that was sent to the portable electronic device;
v) identify the intended recipient and the parcel based on the information read from the portable electronic device; and
vi) trigger the short range wireless radio transceiver to signal the electronically operated locking mechanism of the locker in which the parcel was placed to unlock its door so the parcel may be retrieved from the locker.

2. The parcel locker system as set forth in claim 1, wherein the control device is a mobile phone.

3. The parcel locker system as set forth in claim 1, wherein the processor is further programmed to trigger the long range wireless transceiver to transmit a message to the portable electronic device of the intended recipient and to the sender of the parcel after the intended recipient picks up the parcel.

4. The parcel locker system as set forth in claim 1, wherein the processor is further programmed to:
receive a message transmitted from a portable electronic device operated by a delivery person before the parcel is delivered to the parcel locker system, the message including the information identifying the parcel and the intended recipient of the parcel; and
trigger the long range wireless transceiver to transmit a message to the portable electronic device of the intended recipient and to the sender of the parcel after the intended recipient picks up the parcel.

5. The parcel locker system as set forth in claim 1, further comprising a pedestal in which the control device is mounted, wherein the pedestal is positioned in front of the parcel lockers so that a delivery person and the intended recipient can easily see all the doors of the parcel lockers when interacting with the control device.

6. The parcel locker system as set forth in claim 1, wherein the tag on the parcel is a near field communication (NFC) tag and wherein the short range wireless radio transceiver is an NFC transceiver.

7. A parcel locker system comprising:
a plurality of parcel lockers each including a door and an electrically operated locking mechanism for locking and unlocking the door;
a pedestal or other support positioned in front of the parcel lockers; and
a handheld mobile communication device positioned in the pedestal or other support for controlling access to the parcel lockers, the handheld mobile communication device including—
a) a display;
b) a near field communication (NFC) component;
c) a Bluetooth transmitter;
d) a cellular radio transceiver; and
e) a processor programmed to—
i) direct the NFC component to read a tag on a parcel being delivered to the parcel delivery system to obtain from the tag information identifying the parcel and an intended recipient of the parcel;
ii) trigger the Bluetooth transmitter to signal one of the electronically operated locking mechanisms to unlock its door so the parcel may be placed in the parcel locker;
iii) trigger the cellular radio transceiver to transmit a message to a portable electronic device operated by the intended recipient to notify the intended recipient of the receipt of the parcel in the parcel locker, the message including information identifying the parcel and the recipient;
iv) direct the NFC component to communicate with the portable electronic device operated by the intended recipient when the portable electronic device is placed near the display to read at least part of the information that was sent to the portable electronic device;
v) identify the intended recipient and the parcel based on the information read from the portable electronic device; and
vi) trigger the Bluetooth transmitter to signal the electronically operated locking mechanism of the locker in which the parcel was placed to unlock its door so the parcel may be retrieved from the locker.

8. The parcel locker system as set forth in claim 7, wherein the handheld mobile communication device is a mobile phone.

9. The parcel locker system as set forth in claim 7, wherein the processor is further programmed to trigger the cellular radio transceiver to transmit a message to the portable electronic device of the intended recipient and to the sender of the parcel after the intended recipient picks up the parcel.

10. The parcel locker system as set forth in claim 7, wherein the processor is further programmed to:
receive a message transmitted from a portable electronic device operated by a delivery person before the parcel is delivered to the parcel locker system, the message including the information identifying the parcel and the intended recipient of the parcel; and
trigger the cellular radio transceiver to transmit a message to the portable electronic device of the intended recipient and to the sender of the parcel after the intended recipient picks up the parcel.

11. The parcel locker system as set forth in claim 7, further comprising a receipt printer for printing receipts confirming pickup and delivery of the parcel.

12. The parcel locker system as set forth in claim 7, wherein the tag on the parcel is a near field communication (NFC) tag.

13. An electronically controlled parcel delivery system comprising:
a computer program configured to be stored on non-transitory computer readable memory of a portable device operated by a parcel delivery person, the computer program including—
a code segment for receiving data read from a near field communication (NFC) tag on a shipping label applied to a parcel to be delivered by the parcel delivery person;
a code segment for triggering the portable electronic device to send a message containing information identifying the parcel, an intended recipient of the parcel, and an estimated delivery time for the parcel;
a computer program configured to be stored on non-transitory computer readable memory of a portable electronic device operated by an intended recipient of the parcel, the computer program including—
a code segment for receiving the message sent from the portable electronic device operated by the parcel delivery person; and
a parcel locker system including—
a plurality of parcel lockers each including a door and an electronically operated locking mechanism for locking and unlocking the door;
a pedestal or other support positioned in front of the parcel lockers; and
a handheld mobile communication device positioned in the pedestal or other support for controlling access to the parcel lockers, the handheld mobile communication device including—
a) a display;
b) a near field communication (NFC) component;
c) a Bluetooth transmitter;
d) a cellular radio transmitter; and
e) a processor for controlling operation of the display, the NFC component, the Bluetooth transmitter and the cellular radio transmitter and programmed to—
i) direct the NFC component to read the tag on the parcel as it is delivered to the parcel delivery system to obtain from the tag the information identifying the parcel and the intended recipient of the parcel;
ii) trigger the Bluetooth transmitter to signal one of the electronically operated locking mechanisms to unlock its door so the parcel may be placed in the parcel locker;
iii) trigger the cellular radio transmitter to transmit a message to the portable electronic device operated by the intended recipient to notify the intended recipient of the receipt of the parcel in the parcel locker, the message including information identifying the parcel and the intended recipient and the parcel;
iv) direct the NFC component to communicate with the portable electronic device operated by the intended recipient when the portable electronic device is placed near the display to read at least part of the information that was sent to the portable electronic device;
v) identify the intended recipient and the parcel based on the information read from the portable electronic device; and
vi) trigger the Bluetooth transmitter to signal the electronically operated locking mechanism of the locker in which the parcel was placed to unlock its door so the parcel may be retrieved from the locker.

14. The electronically controlled parcel delivery system as set forth in claim 13, wherein the handheld mobile communication device is a mobile phone.

15. The electronically controlled parcel delivery system as set forth in claim 13, wherein the processor of the handheld mobile communication device is further programmed to trigger the cellular radio transceiver to transmit a message to the portable electronic device of the intended recipient and to the sender of the parcel after the intended recipient picks up the parcel.

16. The electronically controlled parcel delivery system as set forth in claim 13, wherein the processor of the handheld mobile communication device is further programmed to:
receive a message transmitted from a portable electronic device operated by a delivery person before the parcel is delivered to the parcel locker system, the message including the information identifying the parcel and the intended recipient of the parcel; and
trigger the cellular radio transceiver to transmit a message to the portable electronic device of the intended recipient and to the sender of the parcel after the intended recipient picks up the parcel.

17. The electronically controlled parcel delivery system as set forth in claim 13, further comprising a receipt printer for printing receipts confirming pickup and delivery of the parcel.

18. A method of delivering a parcel to a parcel locker system, the method comprising:
scanning a machine readable tag applied to the parcel with a mobile communication device operated by a delivery person to obtain information from the tag that identifies the parcel, a delivery address for the parcel, and the intended recipient of the parcel;
transmitting a message from the mobile communication device to a mobile communication device operated by the intended recipient, the message containing at least some of the information from the tag;
delivering the parcel to the delivery address specified in the information from the tag;
scanning the tag on the parcel with a control device of a parcel locker system located at the delivery address so that the control device can identify the parcel and the intended recipient of the parcel.

19. The method of claim 18, wherein the tag applied to the parcel is a near field communication (NFC) tag.

20. The method of claim 18, wherein the mobile communication device operated by the delivery person, the mobile communication device operated by the intended recipient, and the control device of the parcel locker system are all mobile phones.
